(19) United States
(12) Patent Application Publication
(10) Pub. No.: US 2019/0268580 A1
(43) Pub. Date: Aug. 29, 2019

(54) IMAGE PROCESSING APPARATUS, IMAGE FORMING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Hiroaki Niitsuma, Yokohama-shi (JP); Yoshihisa Nomura, Kashiwa-shi (JP); Masanori Ichikawa, Tokyo (JP); Yosuke Obayashi, Nagareyama-shi (JP); Shigeki Hasui, Tokyo (JP)

(21) Appl. No.: 16/273,405

(22) Filed: Feb. 12, 2019

(30) Foreign Application Priority Data
Feb. 23, 2018 (JP) 2018-031192

(51) Int. Cl. H04N 9/43; G06K 9/66; H04N 1/46

(52) U.S. Cl. CPC H04N 9/43; H04N 1/465; G06K 9/66

(57) ABSTRACT

An image processing apparatus comprises: an obtaining unit configured to obtain image data of an original read by a reading unit; a detection unit configured to detect an object from the image data; a color determination unit configured to determine whether an object detected by the detection unit is a color image or a monochrome image; a conversion unit configured to convert each object determined to be a monochrome image by the color determination unit into a color image; and a display unit configured to perform a display, for each object converted by the conversion unit, in which editing by a user is possible.

### BACKGROUND OF THE INVENTION

### Field of the Invention

The present invention relates to an image processing apparatus, an image forming apparatus, an image processing method, and a non-transitory computer-readable storage medium.

### Description of the Related Art

Conventionally, there is image processing for converting a monochrome image read by a scanner in a multi-function printer (hereinafter referred to as an MFP) into a color image (hereinafter referred to as colorization processing). Conventional colorization processing converts an inputted monochrome image into a color image based on a processing algorithm that is provided in advance. The processing algorithm can be provided with a predetermined setting value, and change the appearance of an image after colorization processing based on a plurality of setting values (for example, refer to Japanese Patent Laid-Open No. 2011-66734).

However, separate from a method of performing image processing by defining setting values in advance, there is a method in accordance with machine learning that evaluates error between data input to a processing model that is provided with a predetermined setting value and output data expected in response to that, and changes setting values so that the error is minimized to thereby realize desired processing. In recent years, advanced image processing in accordance with a machine learning processing model that uses a convolutional neural network (hereinafter referred to as CNN) that simulates a configuration of a person's vision cells has been performed. In the field of colorization processing, causing a CNN to learn from many monochrome image/expected color image pairs so that an output image that is the result of an accurate color conversion with respect to various input images is obtained is known (for example, Satoshi Iizuka, et al, “Let there be Color!: Joint End-to-end Learning of Global and Local Image Priors for Automatic Image Colorization with Simultaneous Classification”, [online] 2016, SIGGRAPH 2016[search on Dec. 26, 2017], Internet).

However, in colorization processing based on machine learning techniques that use a CNN, colorization with respect to an unknown input image that greatly differs to images learned thus far may fail. In addition, in colorization of an office document in which is recorded, for example, a graph for statistics, a case where use of color for a colorized graph may not align with the taste of a user that uses the office document can be considered. Furthermore, even if colorization is performed using a different color to something for which a specific color is actually decided as with a logo, there is a problem in that this cannot be determined on a system side to be a failure of colorization. When an image in line with a user's intention is not obtained by colorization processing, user convenience is diminished.

### SUMMARY OF THE INVENTION

In view of the foregoing problems, the present invention aims to improve user convenience by providing a means for confirming and editing, in accordance with a user operation, a region to colorize, in colorization processing based on a machine learning technique that uses a CNN.

According to one aspect of the present invention, there is provided an image processing apparatus, comprising: an obtaining unit configured to obtain image data of an original read by a reading unit; a detection unit configured to detect an object from the image data; a color determination unit configured to determine whether an object detected by the detection unit is a color image or a monochrome image; a conversion unit configured to convert each object determined to be a monochrome image by the color determination unit into a color image; and a display unit configured to perform a display, for each object converted by the conversion unit, in which editing by a user is possible.

According to another aspect of the present invention, there is provided an image forming apparatus comprising: an image processing apparatus; a reading unit configured to read image data from an original; a printing unit configured to print using image data processed by the image processing apparatus, the image processing apparatus comprising: an obtaining unit configured to obtain image data of an original read by the reading unit; a detection unit configured to detect an object from the image data; a color determination unit configured to determine whether an object detected by the detection unit is a color image or a monochrome image; a conversion unit configured to convert each object determined to be a monochrome image by the color determination unit to a color image; and a display unit configured to perform a display, for each object converted by the conversion unit, in which editing by a user is possible.

According to another aspect of the present invention, there is provided an image processing method, comprising: obtaining image data of an original read by a reading unit; detecting an object from the image data; determining whether a detected object is a color image or a monochrome image; converting each object determined to be a monochrome image to a color image; and performing, by a display unit, a display, for each converted object, in which editing by a user is possible.

According to another aspect of the present invention, there is provided a non-transitory computer-readable storage medium storing a program for causing a computer to function as: an obtaining unit configured to obtain image data of an original read by a reading unit; a detection unit configured to detect an object from the image data; a color determination unit configured to determine whether an object detected by the detection unit is a color image or a monochrome image; a conversion unit configured to convert each object determined to be a monochrome image by the color determination unit to a color image; and a display unit configured to perform a display, for each object converted by the conversion unit, in which editing by a user is possible.

By the present invention, it is possible for a user to confirm and edit a result of colorization processing based on a machine learning technique, and user convenience improves.

Further features of the present invention will become apparent from the following description of exemplary embodiments (with reference to the attached drawings).

### BRIEF DESCRIPTION OF THE DRAWINGS

FIG. 1 illustrates an example of a configuration of a system according to the present embodiment.

FIG. 2 illustrates an example of a hardware configuration of an MFP according to according to embodiments.

FIG. 3 illustrates an example of a configuration of an image processing unit of the MFP according to according to embodiments.

FIG. 4 is a flowchart of copy processing of the MFP according to embodiments.

FIG. 5 is a flowchart of learning processing of the MFP according to embodiments.

FIG. 6 illustrates an example of a learning table according to the present embodiment.

FIG. 7 is a schematic drawing of a processing model of a color conversion unit according to embodiments.

FIGS. 8A to 8D illustrate an example of a configuration of screens of an operation unit of the MFP according to according to embodiments.

FIG. 9 illustrates examples of objects according to the present embodiment.

FIGS. 10A to 10E illustrate an example of a configuration of screens for color editing processing according to embodiments.

### DESCRIPTION OF THE EMBODIMENTS

Hereinafter, embodiments for working the present invention are explained using drawings.

### First Embodiment

Explanation in detail is given below for an embodiment to which the present invention can be applied, with reference to the drawings. Note that the same reference numerals are given to portions having the same function in the drawings, and overlapping explanation will be omitted as appropriate.

[System Configuration]

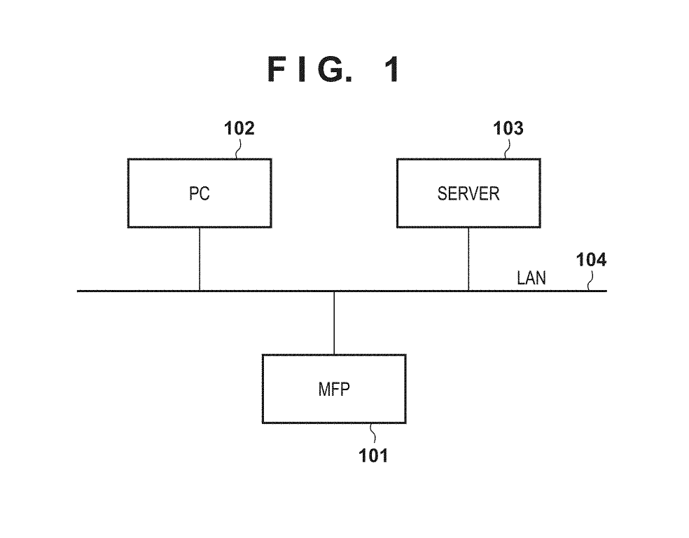

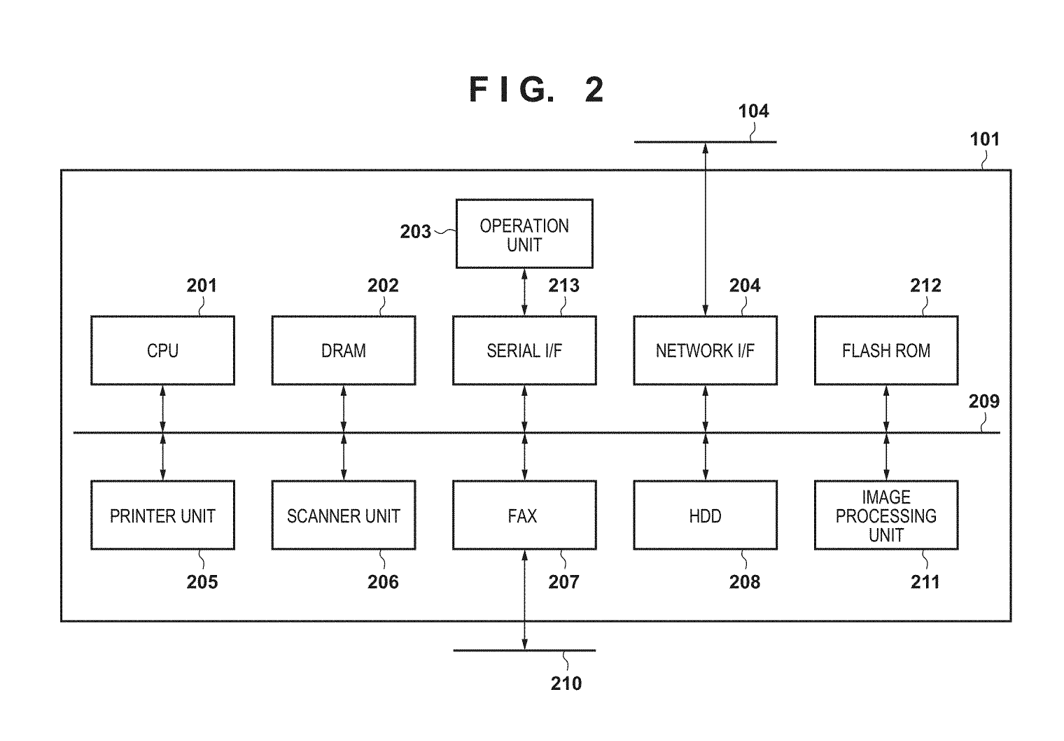

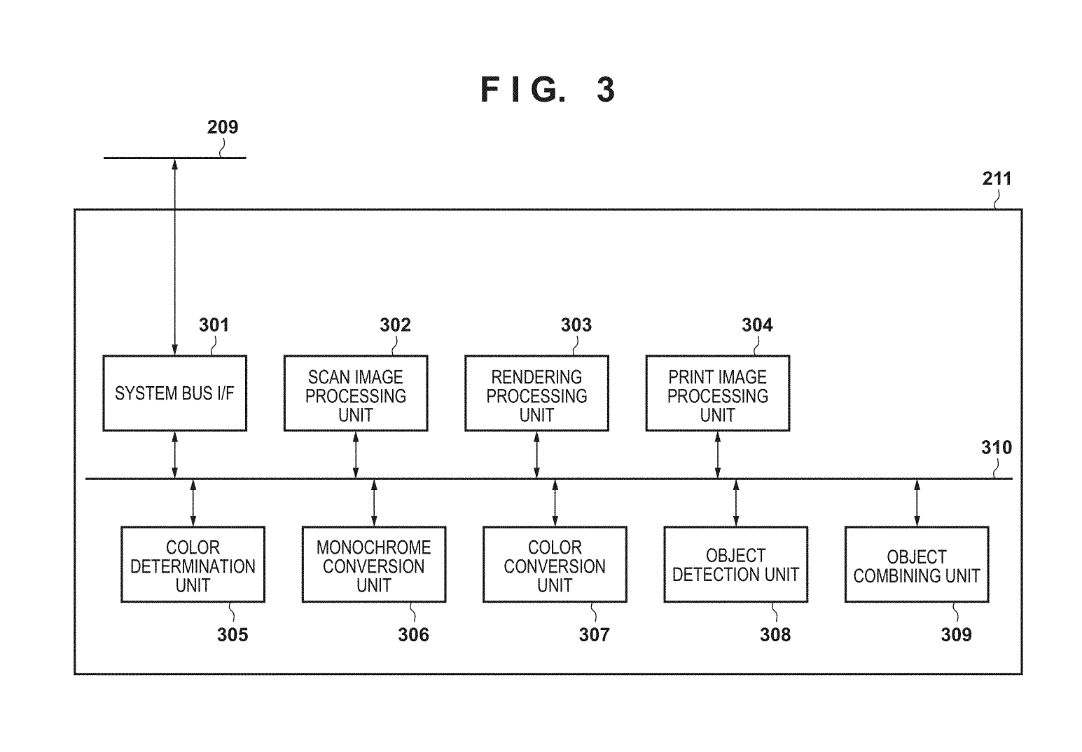

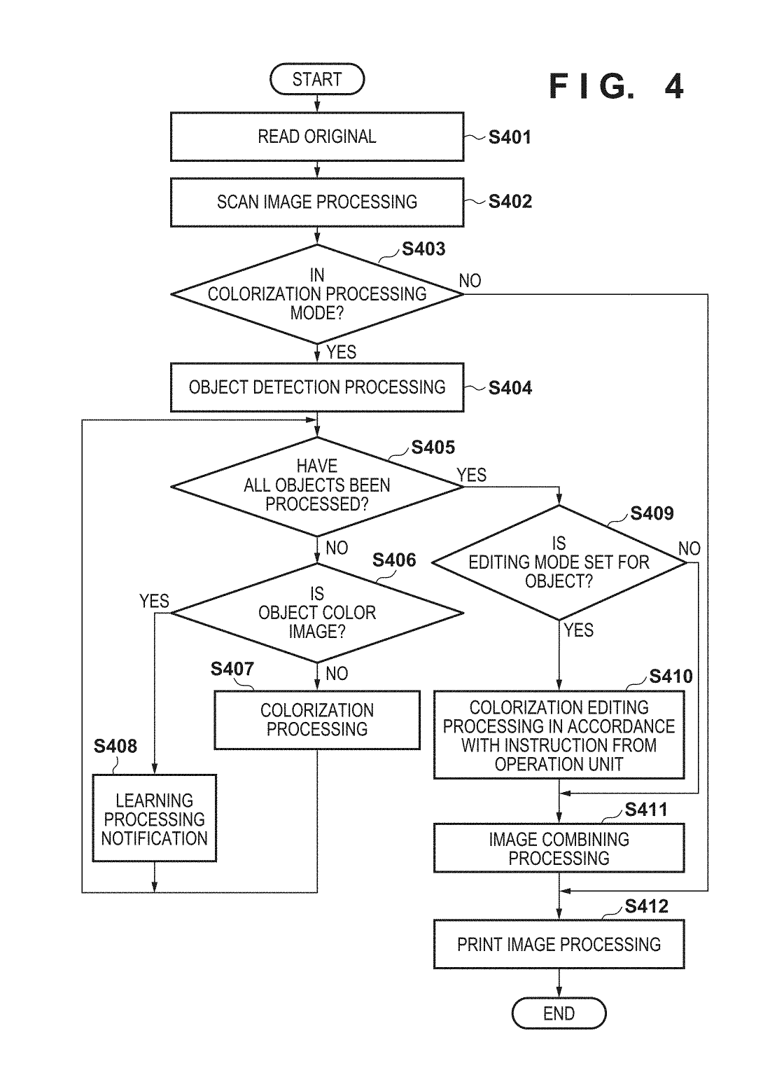

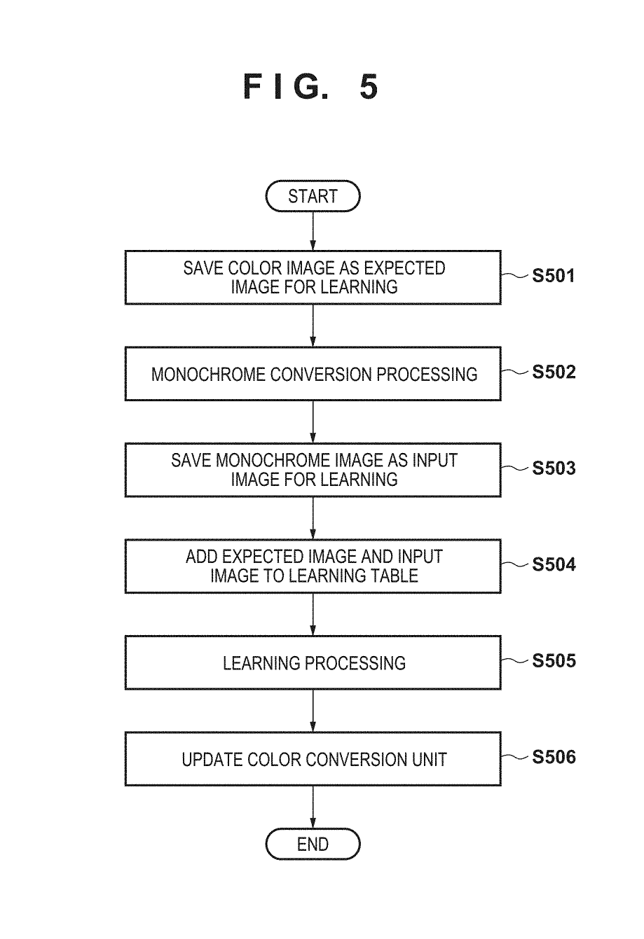

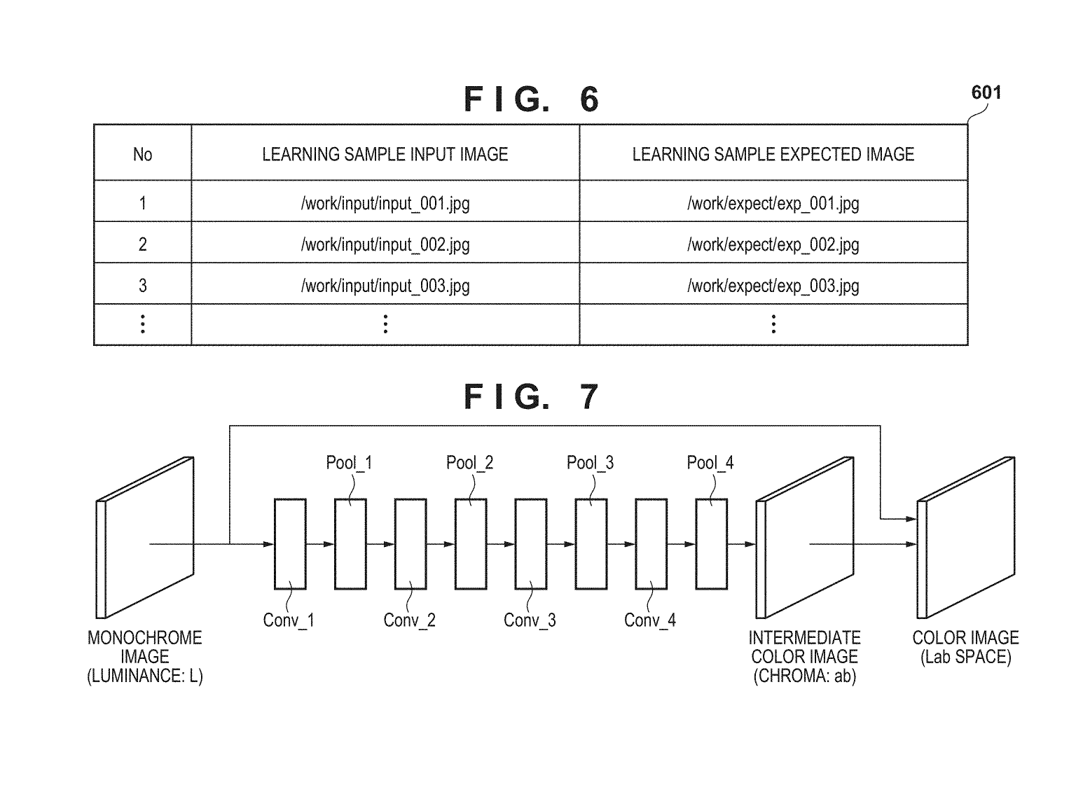

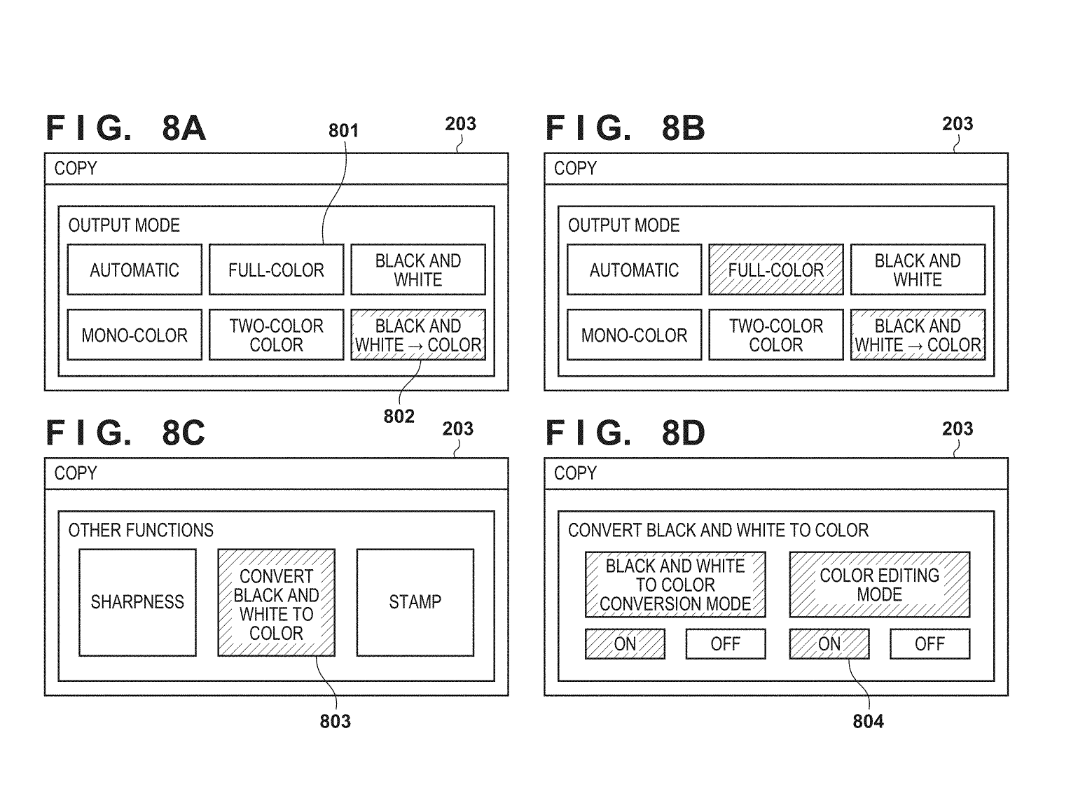

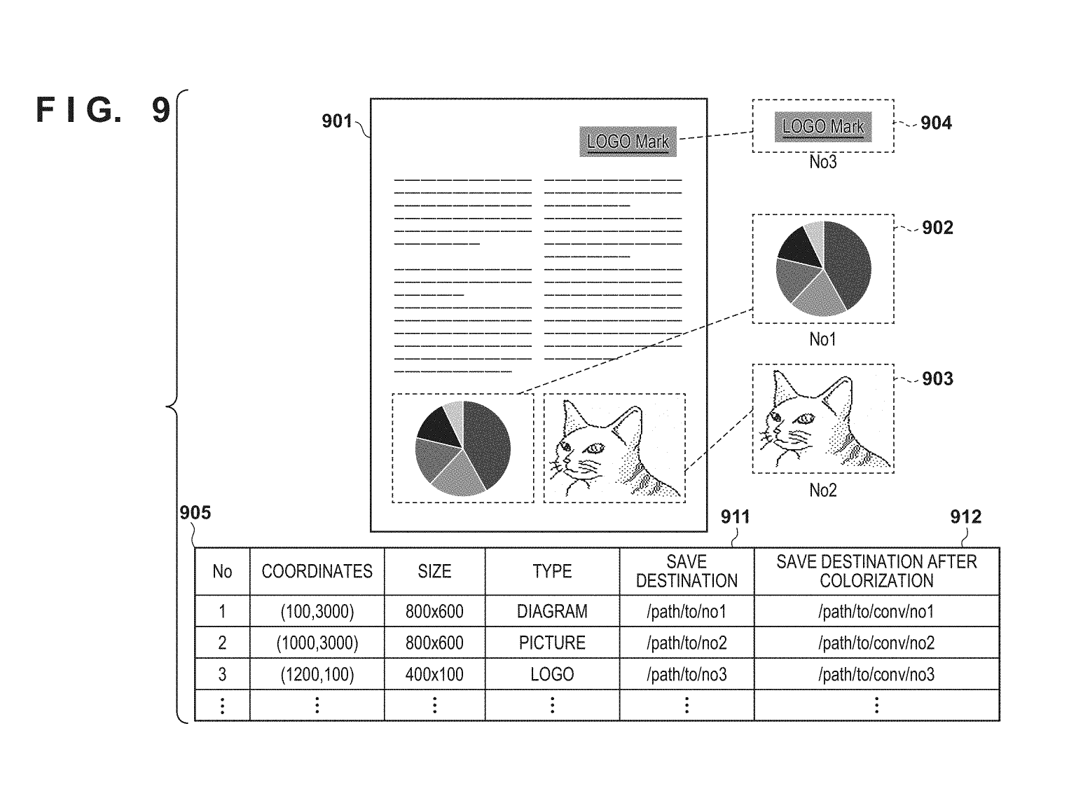

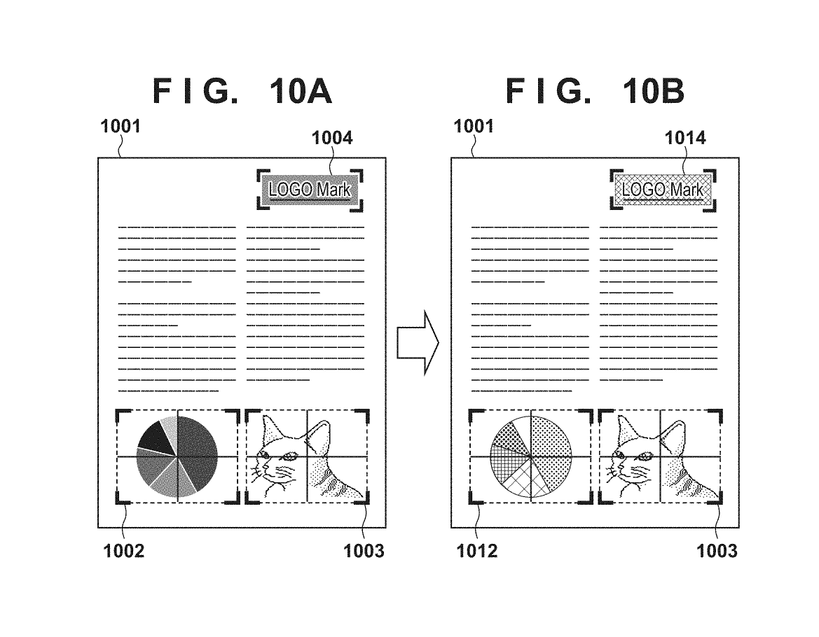

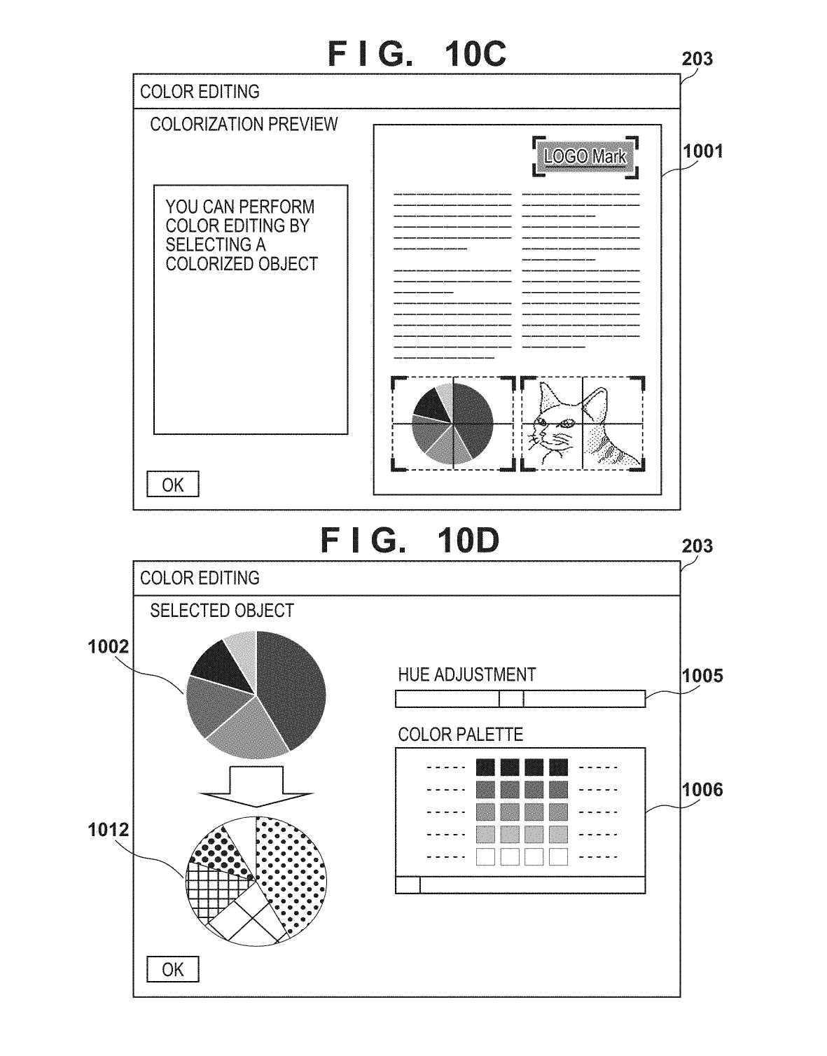

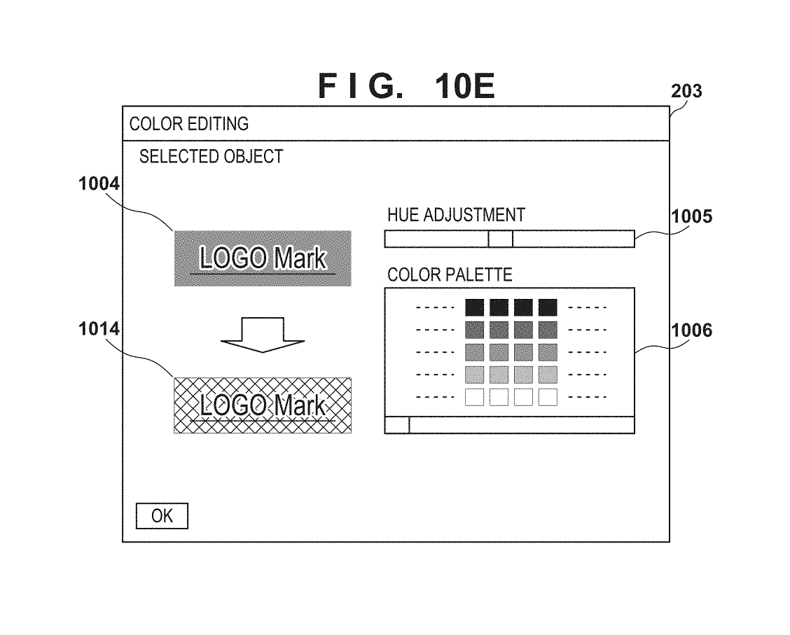

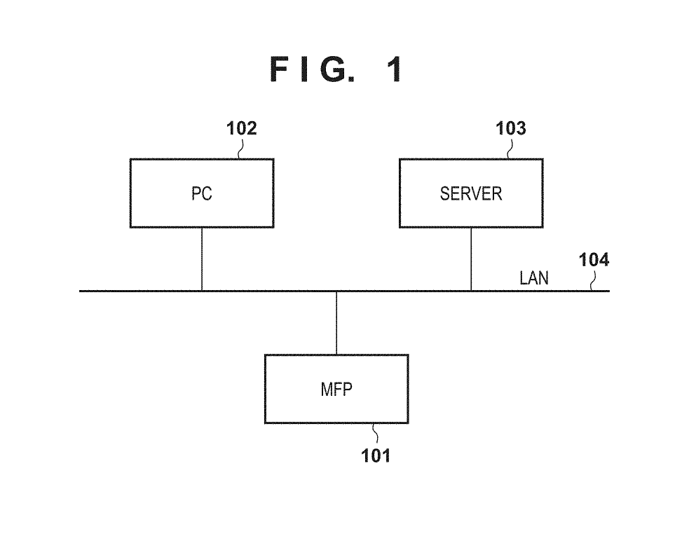

FIG. 1 illustrates an example of a configuration of a system according to the present embodiment. The present system is configured by including an MFP 101, a PC 102, and a server 103, and the apparatuses are communicably connected via a LAN 104. The MFP 101 is an example of an image forming apparatus, and is an apparatus that has a print function, a scanner function, or the like. The PC 102 and the server 103 are information processing apparatuses, and execute processing in cooperation with the MFP 101, as necessary. A network configuration of the LAN 104 is not limited to this, and may be wired or wireless. In addition, although one of each apparatus is illustrated in FIG. 1, there is no limitation to this.

[MFP]

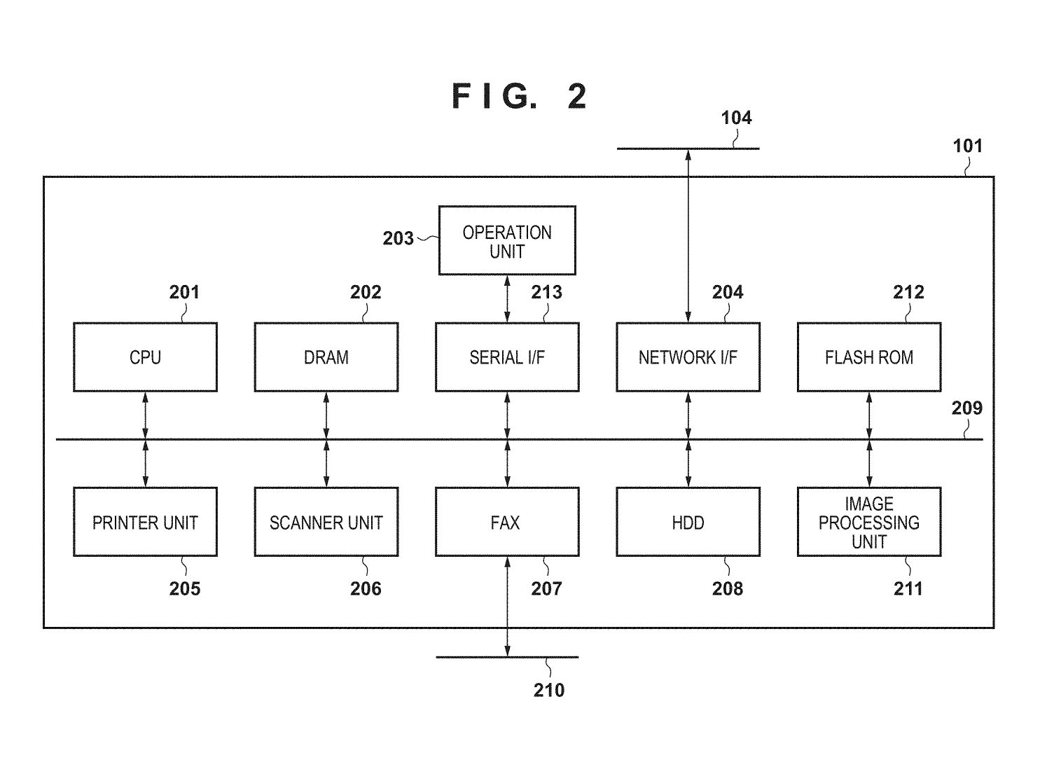

FIG. 2 is a view illustrating an example of a hardware configuration of the MFP 101 according to the present embodiment. A CPU (Central Processing Unit) 201 controls the entirety of the MFP 101. A DRAM (Dynamic Random Access Memory) 202 stores programs that are executed by the CPU 201, and also functions as a work area for temporary data. An operation unit 203 notifies the CPU 201 of an operation by a user via a serial I/F 213. A network I/F 204 connects with the LAN 104 to communicate with an external device. A printer unit 205 prints onto a recording medium (for example, paper), based on image data. A scanner unit 206 is means for reading an original, and generates a scan image by optically reading an image on a recording medium and converting it to an electrical signal.

A FAX 207 connects with a public switched telephone network 210 to perform facsimile communication with an external device. An HDD (Hard Disk Drive) 208 stores a program that is executed by the CPU 201, and is also used as a spool region such as for a print job or a scan job. A system bus 209 is mutually connected to each module, and performs communication between modules. The public switched telephone network 210 interconnects the FAX 207 with an external device. An image processing unit 211 executes a process of converting a print job receives via the network I/F 204 into an image suitable for printing by the printer unit 205, or image processing with respect to a scan image read by the scanner unit 206. In addition, the image processing unit 211 expands image data (PDL codes) receives from an external apparatus via the network I/F 204 and the LAN 104 into bitmap data. In addition, the image processing unit 211 performs image processing as preprocessing for printing of image data by the printer unit 205. Details of the image processing unit 211 are described later. A flash ROM (flash Read Only Memory) 212 stores programs that are executed by the CPU 201, as well as a default setting value of the MFP 101, a default setting value for each user, temporary custom setting values, and the like. The serial I/F 213 interconnects the operation unit 203 and the system bus 209.

(Image Processing Unit)

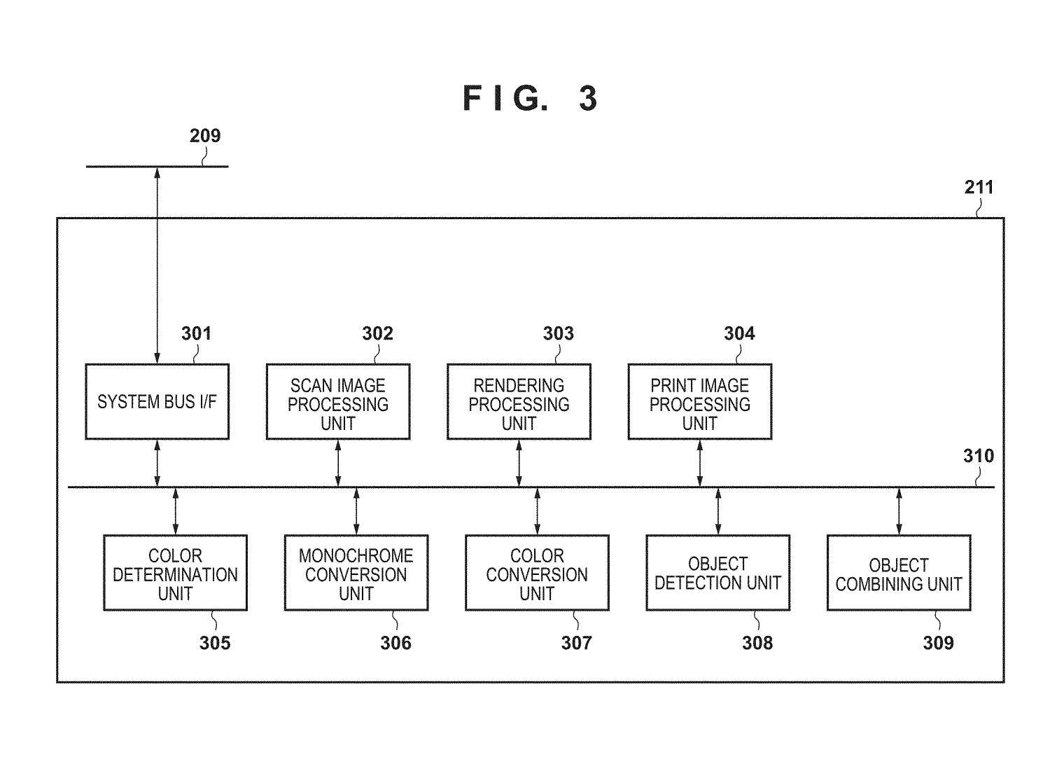

FIG. 3 is a view illustrating an example of an internal configuration of the image processing unit 211 provided by the MFP 101 according to the present embodiment. In FIG. 3, a system bus I/F 301 performs a protocol conversion or arbitration for the system bus 209 and a signal bus 310, to interconnect each module of the image processing unit 211 with each module connected to the system bus 209. A scan image processing unit 302 performs filter processing, an input gamma correction, MTF (Modulation Transfer Function) correction processing, or shading correction processing which is performed on a scan image read by the scanner unit 206. Furthermore, in addition to this, the scan image processing unit 302 performs image processing such as noise elimination, color space conversion, rotation, or compression. A rendering processing unit 303 expands image data (PDL codes) received from an external apparatus into bitmap data.

A print image processing unit 304 performs image processing as preprocessing for printing of image data by the printer unit 205. Preprocessing specifically may be color space conversion processing for converting to RGB or CMYK, halftone processing in accordance with a dither method or an error diffusion method, a gamma correction, or the like. Image data after image processing is outputted to the printer unit 205. Here, in order to output image data to the printer unit 205 in alignment with activation and feeding for the printer unit 205, the print image processing unit 304 temporarily writes image data to the DRAM 202 which is a buffer for timing synchronization. The print image processing unit 304 synchronizes with a timing of feeding of recording media to read image data from the DRAM 202 and output it to the printer unit 205.

A color determination unit 305 determines whether an image processed by the scan image processing unit 302 is a color image or a monochrome image. Here, each pixel of the whole image is scanned, the tint of the pixel is obtained from the value of the R, G, and B components that configure the pixel, the tints are added together, and if a total tint exceeds a predetermined value, then it is determined that the image is a color image. In contrast, if the total tint is less than or equal to the predetermined value, then it is determined that the image is a monochrome image. A monochrome conversion unit 306 performs a monochrome conversion by setting, as pixel values of a monochrome image, values calculated by calculating RGB components for each pixel of the color image processed by the scan image processing unit 302. A color conversion unit 307 converts a monochrome image processed by the scan image processing unit 302 into a color image. In the present embodiment, a processing model is used to perform calculation processing based on a machine learning technique configured by a CNN (Convolutional Neural Network). Details of the color conversion unit 307 are described later.

An object detection unit 308 detects an object from inside scan data processed by the scan image processing unit 302. Here, the object indicates a region of the image such as a logo, a photograph, a diagram, and an illustration other than text. However, there is no limitation to this, and, for example, something that has been turned into a diagram, even if it is text, may be handled as an object (an object region). An object combining unit 309 writes back an object that has been subject to a color conversion by the color conversion unit 307 to the region detected by the object detection unit 308. The signal bus 310 of the image processing unit 211 communicates by making two-way connections to each module.

[Color Conversion Copy Operation]

Using FIG. 4, description is given for a copy operation that outputs to paper after performing a color conversion on a scan image, as colorization processing in the MFP 101. It is assumed that, for the following processing of the operation, except for cases that are specified in particular, the CPU 201 executes processing by providing instructions to each processing unit based on a program stored in the flash ROM 212.

In step S401, the scanner unit 206 reads an original (a recording medium) placed on an original platen (not shown) or a paper conveying unit as image data and saves it in the DRAM 202.

In step S402, the scan image processing unit 302 performs image processing for scanning with respect to the image data read in step S401. The image processing for scanning is described as something performed based on a setting value stored in advance by the flash ROM 212.

In step S403, the CPU 201 determines whether a mode setting for performing colorization processing is set. A colorization processing mode is, for example, something set by a user via a screen provided by the operation unit 203 of the MFP 101. Details of this setting are described later. If the colorization processing mode is set (YES in step S403) the processing transitions to step S404, and if the colorization processing mode is not set (NO in step S403), the processing transitions to step S412.

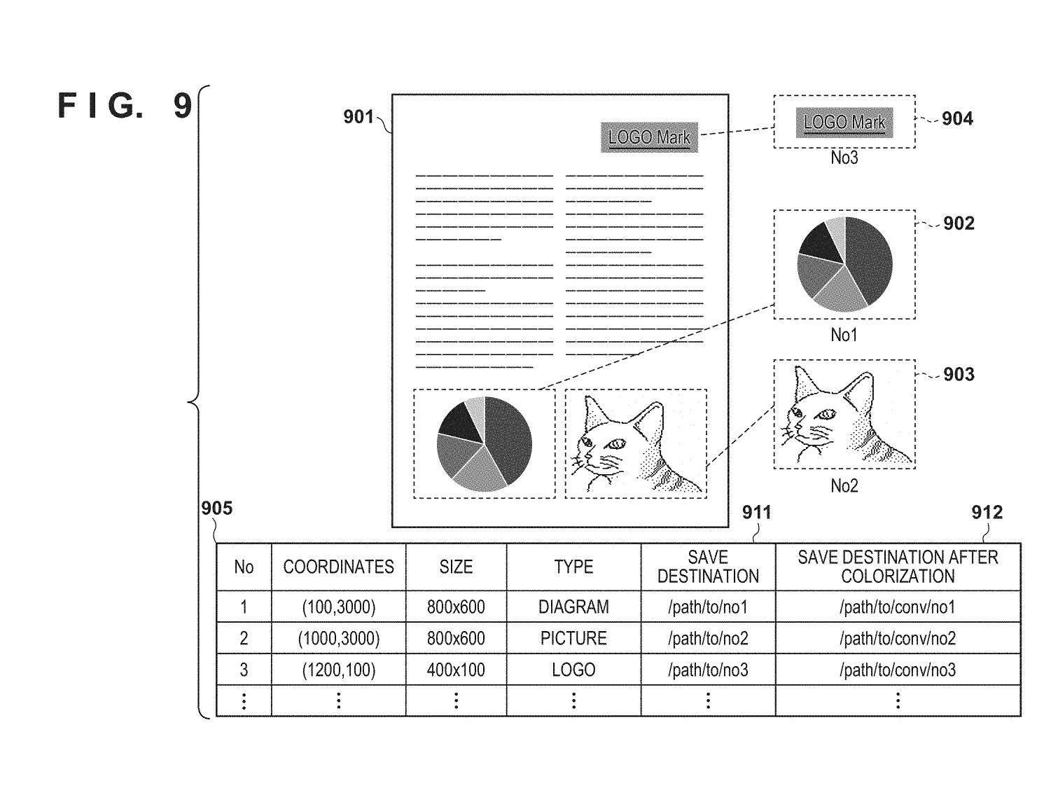

In step S404, the object detection unit 308 detects an object from the image data to which the image processing for scanning was performed in step S402. Here, as an object detection method, pattern matching, a method for turning gradient directions into a histogram to extract feature amounts and detect text or an object, or the like may be given. In the present embodiment, object detection is performed by using a similar method. Note that an object detection method is not limited to those described above, and another method may be used. The object detection unit 308 registers information, such as an image size or coordinate positions in the original image, with respect to the detected object in an object management table, and stores it in the DRAM 202. Details of the object management table are described later using FIG. 9.

In step S405, the CPU 201 determines whether it has executed processing of this flowchart (step S406 through step S408) which are described later, with respect to all objects of the object management table that was created in step S404. If there is an object that is yet to be processed (NO in step S405), the CPU 201 selects one object that is yet to be processed, transitions to step S406, and performs processing. In contrast, upon determining that processing with respect to all objects had ended (YES in step S405), the processing transitions to step S409.

In step S406, the color determination unit 305 determines whether the object detected in step S404 is a monochrome image or a color image. As described above, in this determination, the tint of the pixel is obtained from the value of the R, G, and B components that configure the pixel, the tints are added together, and if a total tint exceeds the predetermined value, then it is determined that the image is a color image. When the object is determined to be a monochrome image (NO in step S406), the processing transitions to step S407. However, when the object is determined to be a color image (YES in step S406), the processing transitions to step S408.

In step S407, the color conversion unit 307 performs colorization processing on the object that was determined to be a monochrome image in step S406. As described above, it is assumed that, for the colorization processing, image processing based on a processing model which has been learned by a CNN is performed. Accordingly, by learning progressing and using parameters calculated based on the details of the learning, a different processing result is output even with the same object. Subsequently, the processing returns to step S405.

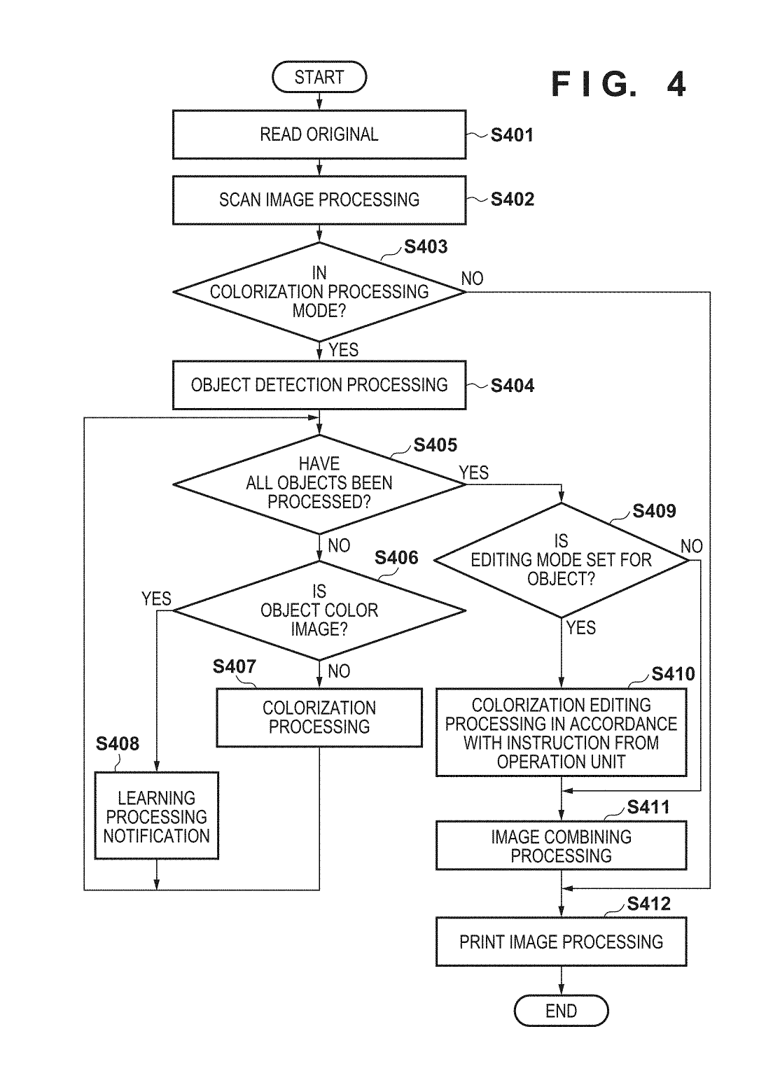

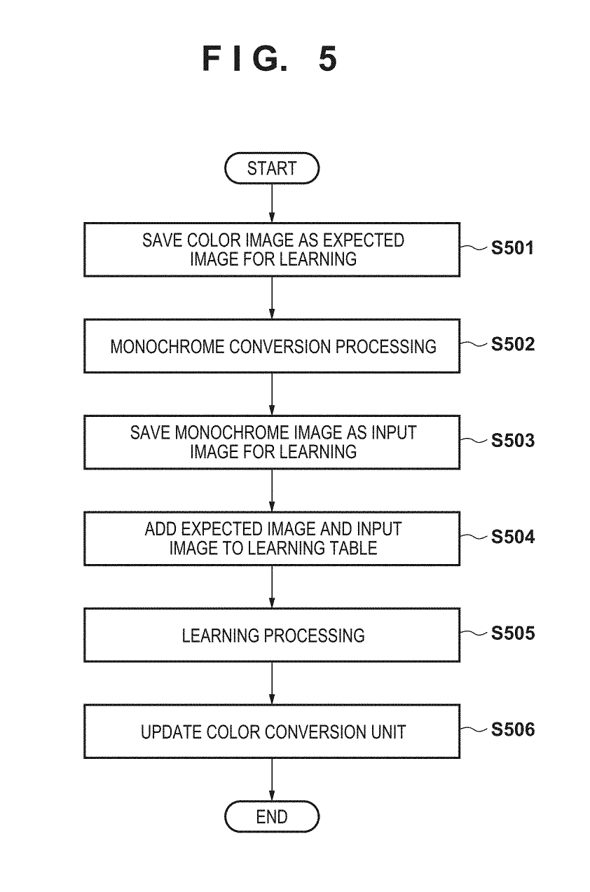

In step S408, the CPU 201 performs notification processing in order to perform learning processing with respect to the object determined to be a color image in step S406. The CPU 201 performs learning processing using the object, based on the learning processing notification. Details of this learning processing are described later using FIG. 5. Subsequently, the processing returns to step S405.

In step S409, the CPU 201 determines whether a mode setting for performing color editing processing is set. The color editing mode is set by a user via the operation unit 203, for example. Details of this setting are described later. If the color editing mode is set (YES in step S409) the processing transitions to step S410, and if the color editing mode is not set (NO in step S409), the processing transitions to step S411.

In step S410, the CPU 201 causes a preview screen, in which is arranged an object for which colorization processing was performed in step S407 and an image read from the DRAM 202 for which the image processing for scanning was performed, to be displayed in the operation unit 203. Furthermore, the CPU 201 accepts input from a user via the operation unit 203, and performs color conversion processing on a colorized object, based on a color editing instruction with respect to the object on which the colorization processing was performed. The CPU 201 then stores the object to which the color editing processing has been performed in the DRAM 202. Details of this processing are described later. Subsequently, the processing proceeds to step S411.

In step S411, the object combining unit 309 performs image combining processing. Here, objects in the image resulting from the image processing for scanning are replaced by the objects resulting from the colorization processing in step S407 and the objects resulting from the correction by the color editing processing in step S410. As a result, image data that includes the object edited by the user is generated. The object combining unit 309 stores the image data after the replacement in the DRAM 202.

In step S412, the print image processing unit 304 performs image processing for printing based on a setting value stored in the flash ROM 212, on the image data stored in the DRAM 202. The printer unit 205 prints the image to a recording medium and outputs the recording medium. This processing flow is then terminated.

Note that, in this processing flow, it is assumed that the processing of step S410 is executed when the color editing processing mode is set. However, configuration may be such that, for example, in the colorization processing in step S407, success/failure of the colorization processing is determined, and, if there is the possibility of failure for even one colorized object, the color editing processing of step S410 is executed.

[Learning Processing]

Using FIG. 5 through FIG. 7, description is given for a processing sequence for performing learning processing and updating the processing model used by the color conversion unit 307, in a case where a learning processing notification is issued in step S409 of FIG. 4. It is assumed that, except for cases that are specified in particular, the CPU 201 executes this processing by providing instructions to each processing unit based on a program stored in the flash ROM 212.

In step S501, out of objects detected by the object detection unit 308 in step S404, the CPU 201 reads out from the DRAM 202 the image data of a color object determined to be a color image by the color determination unit 305 in step S405. The CPU 201 saves the image data of the color object that was read out in the HDD 208 as an expected image of a learning sample. In such a case, the image data may be compressed to a format such as JPEG by a compression/decompression processing unit (not shown) in order to lower a file size.

In step S502, the monochrome conversion unit 306 reads the image data that was saved in the HDD 208, converts it to monochrome image data, and stores the monochrome image data in the DRAM 202. As described above, a monochrome conversion is performed by setting a value calculated by calculating RGB components for each pixel of a color image to a pixel value of a corresponding monochrome image. It is assumed that, in a case where an image read from the HDD 208 is in a compressed format such as JPEG, the monochrome conversion processing is performed after the image is decompressed by the compression/decompression processing unit (not shown).

In step S503, the CPU 201 saves the monochrome image data that was, in step S502, subject to the monochrome conversion and stored in the DRAM 202 to the HDD 208 as an input image for learning processing. In such a case, the image data may be compressed to a format such as JPEG by the compression/decompression processing unit (not shown) in order to lower a file size.

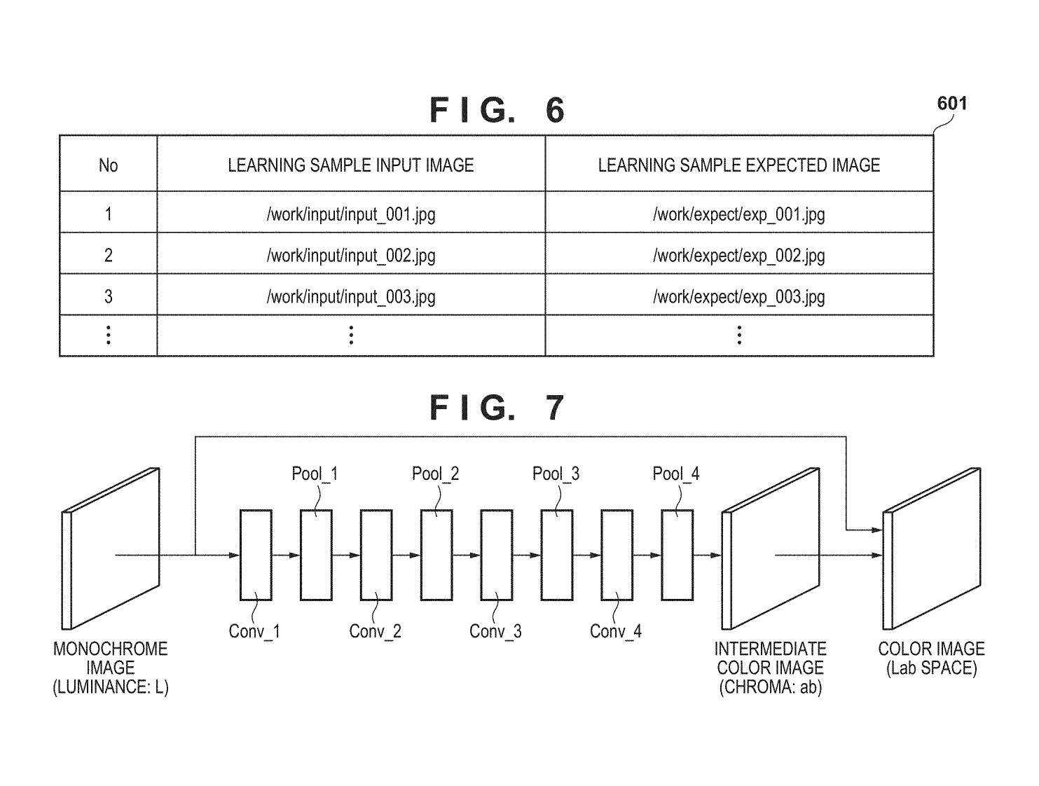

In step S504, the CPU 201 adds the image files stored in step S501 and step S503 to learning table. An example of the configuration of the learning table is illustrated in FIG. 6. A learning table 601 has a path for each image described above, and is stored in the HDD 208. In the learning table 601 of FIG. 6, a learning sample input image indicates the path of a monochrome image saved in step S503, and a learning sample expected image indicates the path of a color image saved in step S501.

In step S505, the CPU 201 performs learning using the images indicated by the learning table 601 that was generated in step S504, and the color conversion unit 307.

FIG. 7 schematically indicates a processing model in the color conversion unit 307. The Conv indicated in FIG. 7 are layers for performing convolution processing. Each convolution layer is provided with a respective non-illustrated two-dimensional filter function (for example, a 5×5 filter), and performs a convolution operation using the two-dimensional filter function with respect to input image data for the convolution layer. The Pool indicated in FIG. 7 are layers for performing pooling processing. Each pooling layer is provided with a respective non-illustrated two-dimensional pooling function, and extracts a pixel matching a condition from pixels inside a window of the two-dimensional pooling function with respect to an input to the pooling layer. For example, in the case of pooling where the window size is 2×2 at a maximum, a pixel having a maximum pixel value is extracted from four pixels inside the window.

The processing model in the color conversion unit 307 according to the present embodiment performs learning with a configuration in which four pairs of a Conv layer and a Pool layer are connected in series, for example. First, a monochrome image which is provided with only luminance information is prepared as input data. This is input to Conv_1 of a first layer, the convolution processing is performed, and next pooling processing is performed by Pool_1. Subsequently, processing by each Conv layer and Pool layer of the second layer through the fourth layer are performed, taking a processing result of a previous layer as an input. An intermediate color image is then generated by mapping the data after the processing of Pool_4 to an ab space of a color space (an Lab space) configured by luminance (L) and chroma (ab). Finally, colorization processing is performed by combining the intermediate color image and the luminance image to make a conversion to a color image.

In step S505, learning is performed for parameters that each layer of the processing model in the color conversion unit 307 is provided with. Firstly, a pair of an input image (a monochrome image) and an expected image (a color image) of the learning table 601 is set as a learning sample, and training data which is an accumulation of these pairs is prepared. Next, deviance between an output image obtained from the processing unit for each layer that configures the processing model, which was inputted with the input image of the learning sample, and the expected image paired with the input image is evaluated by an error function. In the present embodiment, for example, a density difference between the output image and the expected image for each pixel is evaluated by an error function such as cross entropy. Parameters are updated by backpropagation based on obtained evaluation values. Specifically, for example, an optimization function such as a stochastic gradient descent is used to decide an updated parameter value so that the pixel values of an output result approach pixel values corresponding to the learning sample expected image of the learning table 601. This is applied to each layer in an order going back from Pool_4 which is on the output side to the input side to thereby update the parameters of each layer. Note that the flow of processing described above is an example, and a different function or evaluation criteria may be used.

It is assumed that parameters provided by the processing model in the color conversion unit 307 are set at shipment of the MFP 101 with parameters generated by learning in advance with many learning samples (not shown) as initial values. It is assumed that, after shipment, the parameters are updated based on the learning processing described above, each time the MFP 101 is used.

In step S506, the CPU 201 updates the processing model in the color conversion unit 307 by the learning processing of step S505 completing. Next, this processing flow is terminated. It is assumed that the learning processing is executed after detecting that the processing for all objects has ended in step S405, after the learning processing notification in step S408 of FIG. 4.

[Colorization Processing Mode Setting]

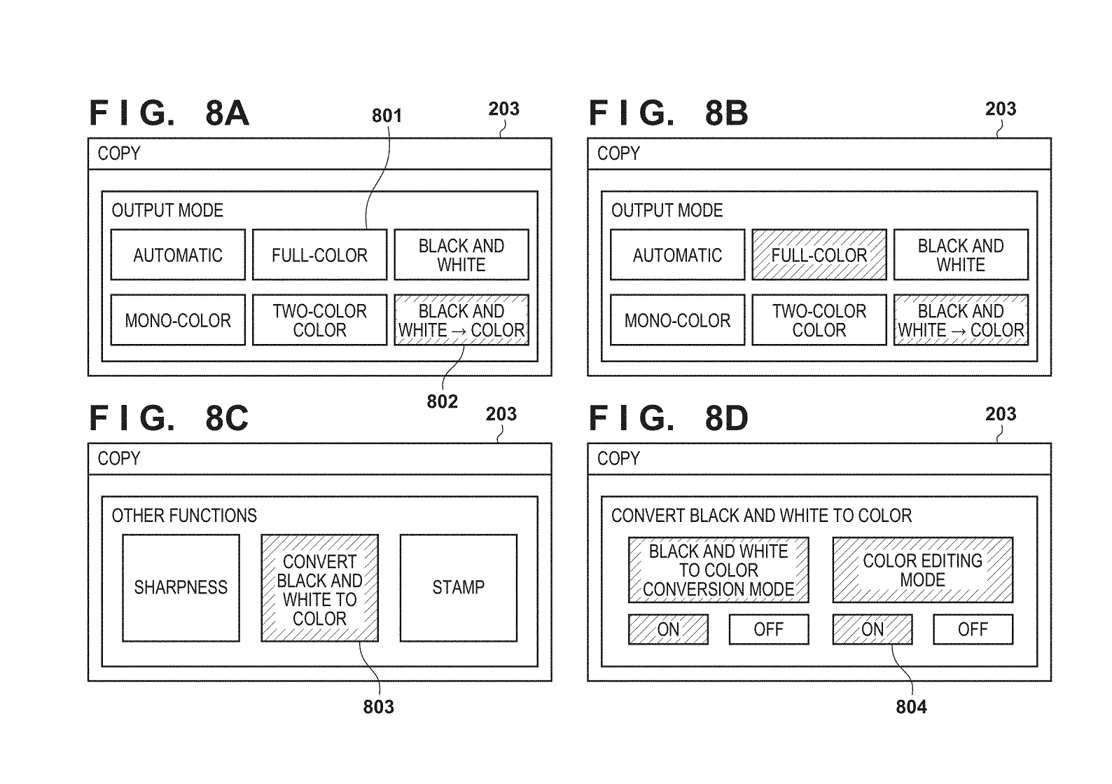

Using FIGS. 8A to 8D, description is given for a display example of screens in the operation unit 203 of the MFP 101, for colorization processing mode settings in the present embodiment. FIG. 8A and FIG. 8B illustrate a copy output mode setting screen. In these output mode setting screens, the colorization processing mode is set to enabled in accordance with a designation of “full color” output (a button 801) or a designation of output of “black and white→color” (a button 802). In addition, FIG. 8C illustrates a copy function setting screen, and a “convert black and white to color” button 803 is displayed. A user can press the button 803 to thereby set execution of a function to convert black and white to color. In the screen of FIG. 8D, which is displayed after the button 803 is pressed, a black and white to color conversion mode is already set, and the colorization processing mode is set to enabled. Furthermore, the screen illustrated in FIG. 8D is configured by including a setting for the color editing mode, and the color editing mode is set to enabled by a user pressing the button 804. Note that the color editing mode may be set to be enabled by default.

[Object Management Table]

Using FIG. 9, illustration is given for an example in which objects are detected from an original read by the scanner unit 206. Image data 901 has been subject to the image processing for scanning in step S402 of FIG. 4. Objects 902, 903, and 904 are a diagram, a photograph, and a logo that have been detected as objects from the image data 901 in in step S404 of FIG. 4. Description is giving here assuming that three objects have been detected. An object management table 905 is a table for managing each detected object, and is held in the DRAM 202. The object management table 905 holds in association an object number for uniquely identifying an object, coordinates in the image data 901, an image size, save destination information 911, and save destination information 912 for after the color conversion processing.

Note that the object information managed by the object management table 905 is not limited to the information described above. For example, an object type, a not-shown rotation angle, color information, a determination result of success/failure in a case of determining a colorization processing result, or the like may be additionally provided as attribute information.

[Color Editing Processing]

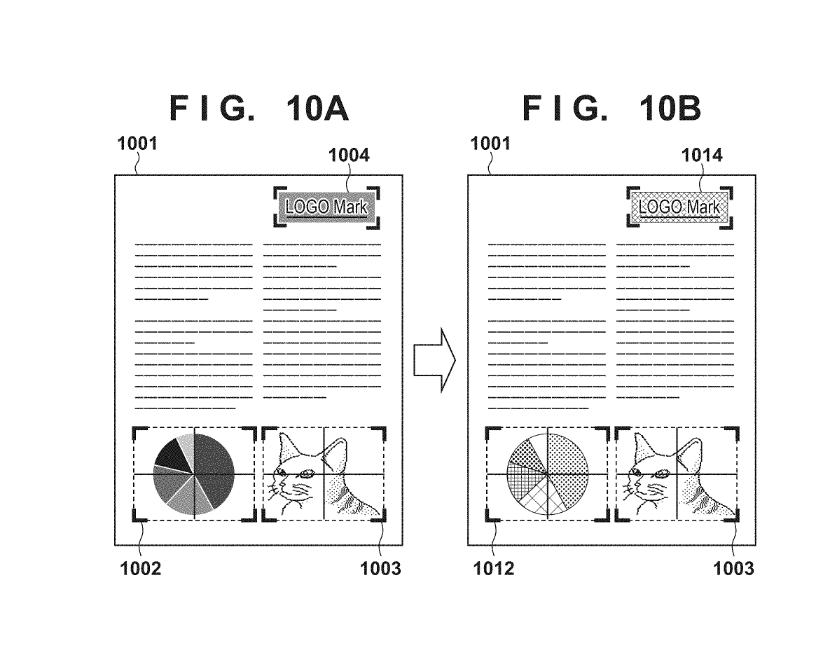

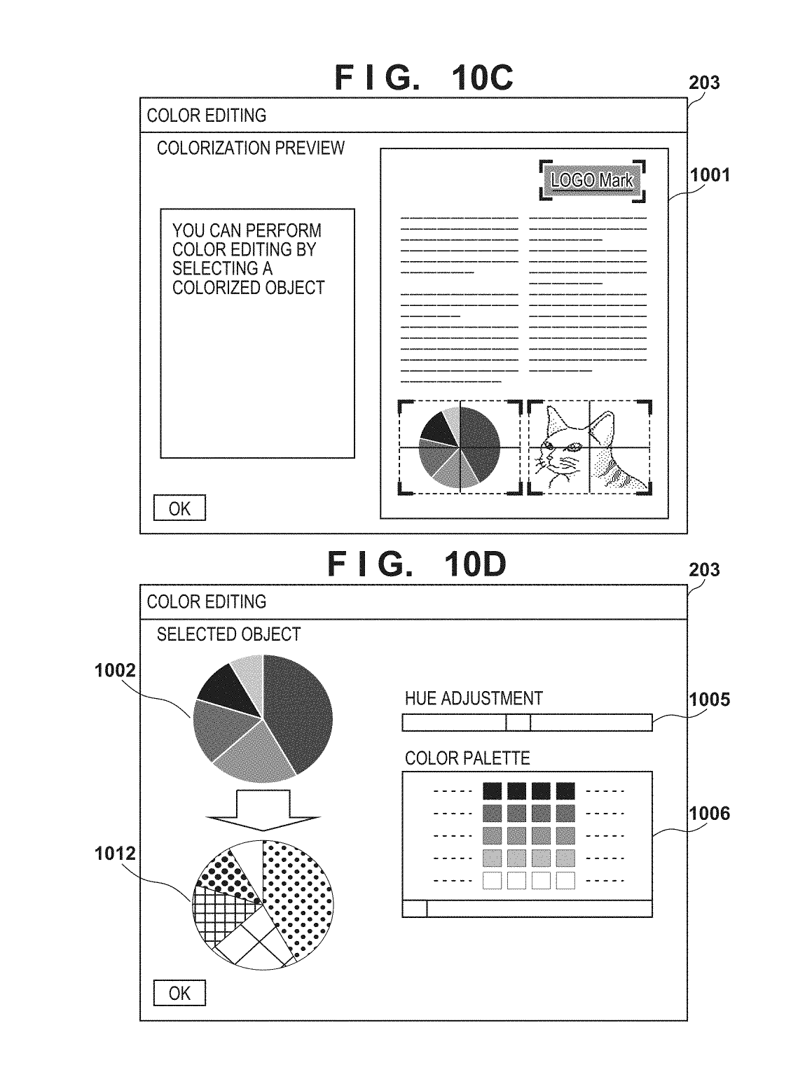

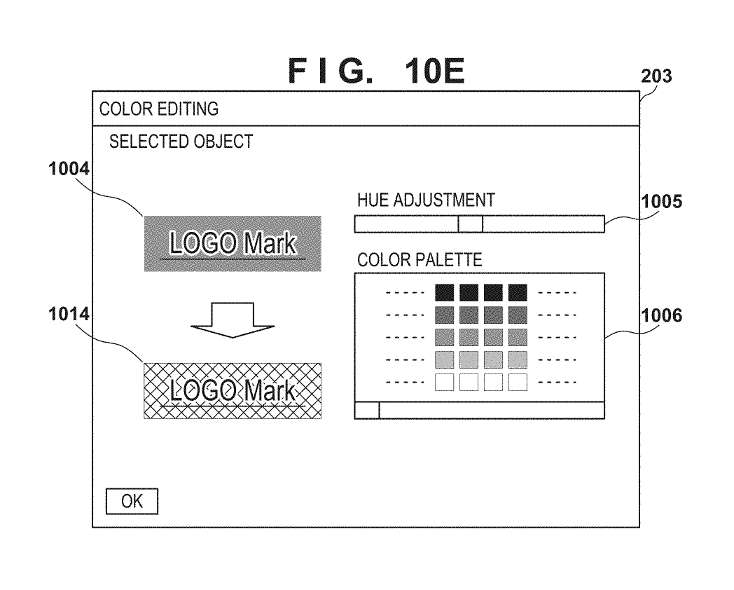

Using an example of display by the operation unit 203 for color editing processing illustrated in FIG. 10A to FIG. 10E, description is given regarding details of the color editing processing performed in step S410 of FIG. 4 mentioned above.

Image data 1001 of FIG. 10A is an image that is obtained when the flow transitions from step S405 of FIG. 4 to step S409 (YES in step S405). The image data 1001 is displayed on the operation unit 203 as in FIG. 10C, as a preview screen in which are arranged the image to which the image processing for scanning was performed in step S402, and objects for which the colorization processing was performed in step S407.

In FIG. 10A, objects 1002, 1003, and 1004 are objects that were detected in step S402 of FIG. 4, similarly to with the image data 901 of FIG. 9, and the colorization processing in step S407 is performed with respect to these objects.

A user performs color editing for a colorized object by referring to this screen displayed on the operation unit 203 which is a display unit, and selecting any object via the operation unit 203. FIG. 10D and FIG. 10E each illustrate an example of a configuration of a color editing screen displayed by the operation unit 203 in a case of accepting an instruction from a user for the objects 1002 and 1004, respectively, as an object to which color editing is to be performed.

In the color editing screens illustrated in FIG. 10D and FIG. 10E, a slide bar 1005 for adjusting a hue, and a color palette 1006 for selecting and designating a color to use are arranged for the color editing. The slide bar 1005, which is for adjusting the hue, is suitable for adjusting the hue of a graph as with the object 1002, in alignment with a user's preference. For example, the object 1002 is displayed as an object 1012 as a result of the object 1002 being adjusted in accordance with the position of the slide bar 1005. Both of the objects 1002 and 1012 are displayed so that a comparison of before and after the adjustment is evident.

The color palette 1006 for selecting color is suitable for designating a specific color to use, such as a corporate color, with respect to a logo as with the object 1004. For example, the object 1004 is displayed as an object 1014 as a result of the object 1004 being adjusted in accordance with a selected color. Both of the objects 1004 and 1014 are displayed so that a comparison of before and after the adjustment is evident.

When color editing operations by the color editing screens illustrated in FIG. 10D and FIG. 10E is complete, a preview screen of FIG. 10C is displayed. In the operation unit 203, a result of updating from the original display of FIG. 10A to a display in which color-edited objects are replaced as illustrated in FIG. 10B is displayed as a preview screen.

Although not illustrated by FIG. 10C, the objects may be shown on the screen as monochrome images from before the colorization processing was performed to enable a comparison. In FIG. 10D and FIG. 10E as well, the objects may be displayed on the screen as monochrome images from before the colorization processing was performed to enable a comparison. In addition, configuration may be taken to enable, for each object, a designation for returning the object to a monochrome image from before the colorization processing.

In addition, the foregoing example gives a method for adjusting hue in accordance with a slide bar and designating colors by a color palette as a method for editing an object, but there is no limitation to this method. For example, fields that allow the input of color values for each color of R, G, and B may be provided.

In addition, although one object is handled as the object 1002 which corresponds to a graph in example of FIG. 10A to FIG. 10E described above, more detailed color designation for each region may be enabled when editing. In addition, configuration may be taken to change a designation method used in editing for each type of object.

Although a configuration for displaying the screens illustrated by FIG. 10A to FIG. 10E on the operation unit 203 provided by the MFP 101 was given in the example described above, there is no limitation to this. For example, configuration may be taken to cause a display unit provided by the PC 102 to display the screens, via the LAN 104. In such a case, more detailed settings are possible because it is possible to display on a display unit (display) that is larger than the operation unit 203 which the MFP 101 is provided with.

Therefore, by the present embodiment, it is possible to present a colorization processing result to a user, and provide the user with means for instructing color editing of a colorized object. As a result, convenience for the user improves.

### Other Embodiments

The present invention is not limited to the foregoing embodiments. Other configuration examples are described below.

The configuration of the processing model of the color conversion unit 307 is not limited to the configuration illustrated in FIG. 7 where four pairs of a convolution layer (Conv layer) and a pooling layer (Pool layer) are connected in series. For example, the number of convolution layers and pooling layers may be increased or decreased, and the filter size or the size of the pooling function may be increased or decreased. Furthermore, a layer for performing other processing (for example, a fully-connected layer) may be added as appropriate. For example, if the number of pairs of a convolution layer and a pooling layer is reduced, it is possible to shorten the amount of time for the learning processing (step S505), and conversely, if the number of pairs is increased, the probability of obtaining good colorization conversion results with respect to more input images increases.

In addition, the learning processing which is performed in step S505 of FIG. 5 may be performed by a GPU (Graphical Processing Unit) (not shown) connected to the system bus 209, and not simply the CPU 201. In addition, the learning processing may be performed on the server 103 which is connected to the LAN 104 via the network I/F 204, while communication is performed as appropriate. By this, it is possible to perform the learning processing at higher speed, and it is possible to reduce downtime of the colorization conversion processing due to the learning processing.

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-031192, filed Feb. 23, 2018, which is hereby incorporated by reference herein in its entirety.

What is claimed is:

1. An image processing apparatus, comprising:
an obtaining unit configured to obtain image data of an original read by a reading unit;
a detection unit configured to detect an object from the image data;
a color determination unit configured to determine whether an object detected by the detection unit is a color image or a monochrome image;
a conversion unit configured to convert each object determined to be a monochrome image by the color determination unit into a color image; and
a display unit configured to perform a display, for each object converted by the conversion unit, in which editing by a user is possible.

2. The image processing apparatus according to claim 1, wherein the display unit displays a slide bar for accepting adjusting of a hue of an object.

3. The image processing apparatus according to claim 1, wherein the display unit displays a color palette for designating a color for an object.

4. The image processing apparatus according to claim 1, further comprising a setting unit configured to perform a setting to enable editing with respect to an object in accordance with the display unit.

5. The image processing apparatus according to claim 1, wherein the display unit displays by switching a method for editing an object in accordance with a type of the object.

6. The image processing apparatus according to claim 1, wherein the display unit performs, with respect to each object converted by the conversion unit, a display in which a change to a monochrome image for before the conversion is possible.

7. The image processing apparatus according to claim 1, wherein the object is any type out of an illustration, a diagram, a photograph, and a logo.

8. The image processing apparatus according to claim 1, wherein the conversion unit uses image data of an object determined to be a color image by the color determination unit to perform calculation processing to calculate a parameter for converting the object.

9. The image processing apparatus according to claim 8, wherein the calculation processing is processing in accordance with machine learning that uses image data of an object determined to be a color image by the color determination unit, and image data obtained by performing monochrome conversion processing on the image data of the object.

10. An image forming apparatus comprising:
an image processing apparatus;
a reading unit configured to read image data from an original;
a printing unit configured to print using image data processed by the image processing apparatus,
the image processing apparatus comprising:
an obtaining unit configured to obtain image data of an original read by the reading unit;
a detection unit configured to detect an object from the image data;
a color determination unit configured to determine whether an object detected by the detection unit is a color image or a monochrome image;
a conversion unit configured to convert each object determined to be a monochrome image by the color determination unit to a color image; and
a display unit configured to perform a display, for each object converted by the conversion unit, in which editing by a user is possible.

11. An image processing method, comprising:
obtaining image data of an original read by a reading unit;
detecting an object from the image data;
determining whether a detected object is a color image or a monochrome image;
converting each object determined to be a monochrome image to a color image; and
performing, by a display unit, a display, for each converted object, in which editing by a user is possible.

12. A non-transitory computer-readable storage medium storing a program for causing a computer to function as:
an obtaining unit configured to obtain image data of an original read by a reading unit;
a detection unit configured to detect an object from the image data;
a color determination unit configured to determine whether an object detected by the detection unit is a color image or a monochrome image;
a conversion unit configured to convert each object determined to be a monochrome image by the color determination unit to a color image; and
a display unit configured to perform a display, for each object converted by the conversion unit, in which editing by a user is possible.
